(19) United States
(12) Patent Application Publication
(10) Pub. No.: US 2013/0317140 A1
(43) Pub. Date: Nov. 28, 2013

(54) POLYMER COMPOSITION CONTAINING A POLYMER, WHICH POLYMER CONTAINS MONOMER UNITS OF A DIMERISED FATTY ACID

(71) Applicants: Zeynep Özyürek, Maastricht (NL); Atze Jan Nijenhuis, Sittard (NL); Paul Willem Jan Van Den Heuvel, Maastricht (NL); Francois Antoine Marie Buijsch Op Den, Voerendaal (NL)

(72) Inventors: Zeynep Özyürek, Maastricht (NL); Atze Jan Nijenhuis, Sittard (NL); Paul Willem Jan Van Den Heuvel, Maastricht (NL); Francois Antoine Marie Buijsch Op Den, Voerendaal (NL)

(73) Assignee: DSM IP Assets B.V., Heerlen (NL)

(21) Appl. No.: 13/992,427

(22) PCT Filed: Dec. 12, 2011
(86) PCT No.: PCT/EP2011/072437

§ 371 Date: Aug. 19, 2013

(30) Foreign Application Priority Data
Dec. 13, 2010 (EP) 10194768.7

(51) Int. Cl. C08K 5/1515

(52) U.S. Cl. CPC C08K 5/1515
USPC 524/114

(57) ABSTRACT

A polymer composition containing a polymer, which polymer contains a residue of a dimerised fatty acid and/or a derivative thereof, which polymer composition contains an epoxidized plasticizer.

The invention relates to a polymer composition containing a polymer, which polymer contains residues of a dimerised fatty acid and/or a derivative thereof.

The use in polymers, of residues that may be obtained from renewable sources is increasingly important. The use of the monomer units obtainable from renewable resources that need not be produced from fossil carbon is a desirable way of reducing the greenhouse gasses released by the production of polymers.

A good example is the use of a dimerised fatty acid residue in polymers. Dimerised fatty acid residues are used to impart flexibility to a polymer.

From US 2006/0235190 a semi crystalline, melt processable, partially aromatic copolyamide is known containing a residue of a dimerised fatty acid.

The dimerised fatty acid contains two carboxylic groups that may be used for copolymerizing the dimerised fatty acid. In order to copolymerize the dimerised fatty acid into the polyamide aliphatic diamines, for example hexamethylene diamine, are used. The same principle is for example known for thermoplastic elastomers containing polyester hard segments. In that case the dimerised fatty acid may be used without the modification of the two carboxylic acid groups.

The flexibility of the polymer containing residues of the dimerised fatty acid is enhanced in view of the same polymer not containing the residue. Also the glass transition temperature is reduced to a lower level.

For a lot of polymer applications a low glass temperature is required, to impart flexibility at low temperatures. Good examples are automotive parts that need to be able to withstand deformations and impact at very low temperatures.

A further decrease of the glass transition temperature might be obtained by increasing the amount of the residues of the dimerised fatty acid. This however results in an undesired reduction of the melting temperature of the polymer and deterioration of mechanical properties, for example decrease in stiffness and increase in creep of the polymer. Furthermore the decrease in glass transition temperature is only moderate.

This is highly undesirable, since the same parts also have to be able to withstand very high temperatures, for example during the painting process of the car, because the parts are used under the hood, or the parts get exposed to the sun.

Object of the invention is therefore to provide a polymer composition containing a polymer, which polymer contains residues of a dimerised fatty acid and/or a derivative thereof, which polymer composition has a decreased glass transition temperature, while maintaining its melting temperature at a higher level than the known polymer composition.

Surprisingly this object is obtained by providing a polymer composition that contains an epoxidized plasticizer.

The polymer composition according to the inventions shows a decrease in glass transition temperature, while maintaining the melting or softening temperature at a high level.

A further advantage is that mechanical properties of the polymer composition are maintained at a higher level, especially the stiffness at room temperature (23° C.).

Examples of epoxidized plasticizers include epoxidized polybutadiene, epoxydized polybutadiene block copolymers, epoxidized vegetable oils and epoxidized modified vegerable oils, such as for example oils of esterified epoxidized fatty acids.

In principle all known epoxidized esterified fatty acids may be used, like for example fatty acid esters of ethanol, 2-ethylhexanol, esters of fatty esters of diols, like for example ethylene glycol and butylene glycol or the esters of multi-functional alcohols, like for example trimethylol propane and pentaerytritol.

Preferably epoxidized vegetable oils are used, more preferably epoxidized linseed oil or tall oil are used, most preferably epoxidized soybean oil is used.

Good results are obtained if the epoxidized plasticizer contains between 0.1 and 15 wt. % of oxyrane oxygen, preferably between 1 and 10 wt. %, more preferably between 2 and 8 wt. %.

Epoxidized vegetable oils and modified oils may be obtained by oxidizing vegetable oils and modified vegetable oils with peroxide acids.

The dimerised fatty acids may be obtained from monomeric unsaturated fatty acids by an oligomerisation reaction. The oligomer mixture is further processed, for example by distillation, to yield a mixture having a high content of the dimerised fatty acid. The double bonds in the dimerised fatty acid may be saturated by catalytic hydrogenation. The term dimerised fatty acid as it is used here relates to both types of these dimerised fatty acids, the saturated and the unsaturated. It is preferred that the dimerised fatty acid is saturated.

It is also possible to produce derivatives of the dimerised fatty acid. For example a dimerised fatty diol may be obtained as a derivative of the dimerised fatty acid by hydrogenation of the carboxylic acid groups of the dimerised fatty acid, or of an ester group made thereof. Further derivatives may be obtained by converting the carboxylic acid groups, or the ester groups made thereof, into an amide group, a nitril group, an amine group or an isocyanate group.

The dimerised fatty acids may contain from 32 up to 44 carbon atoms. Preferably the dimerised fatty acid contains 36 carbon atoms. The amount of C-atoms normally is an average value, since the dimerised fatty acids normally are commercially available as a mixture.

Further details relating to the structure and the properties of the dimerised fatty acids may be found in the corresponding leaflet “Pripol C36-Dimer acid” of the company UNICHEMA (Emmerich, Germany) or in the brochure of the Company COGNIS (Dusseldorf, Germany) “Empol Dimer and Poly-basic Acids; Technical Bulletin 114C (1997)”.

In the production of the polymer containing the residue of the dimerised fatty acid and/or a derivative thereof the dimerised fatty acid and its derivative may be used as a monomer or as a pre-cursor oligomer or polymer. In one example the pre-cursor oligomer or polymer is a polyester, formed of dimerised fatty acid and/or dimerised fatty diol with any combination of diols or dicarboxylic acids. In another example the pre-cursor oligomer or polymer is a polyamide, formed of dimerised fatty acid and/or dimerised fatty diamines with any combination of diamines or dicarboxylic acids forming polyamides.

In a preferred embodiment the pre-cursor is a precursor oligomer or polymer of a dimerised fatty acid and a dimerised fatty amine. Depending on the ratio of dimerised fatty acids and dimerised fatty amines as well as the degree of polymerization of the fatty acid and the fatty amine the endgoups of the precursor are tuned to be acid groups or amine groups. Depending on the further monomers and/or pre-polymers that that are used to produce the final polymer, it might be desirable to have acid endgroups or amine endgroups.

The precursor oligomer or polymer preferably has a number average molecular weight (Mn) of at least 600 kg/kmol, more preferably at least 1000 kg/kmol, even more preferably at least 2000 kg/kmol. The Mn is preferably at most 5000 kg/kmol, more preferably at most 2500 kg.kmol.

Examples of polymers containing the residue of the dimerised fatty acid and/or derivatives thereof are thermoplastic elastomers having hard segments of polyester, nylon and polycarbonate, the soft segments containing the residue of the dimerised fatty acid and/or a derivative.

Preferably the thermoplastic elastomer is a polymer containing hard segments of polyester and the soft segments containing the residue of a dimerised fatty acid and/or a derivative.

Such a thermoplastic elastomer suitably contains hard segments that are built up from repeating units derived from at least one alkylene diol and at least one aromatic dicarboxylic acid or an ester thereof. The linear or cycloaliphatic alkylene diol contains generally 2-8 C-atoms, preferably 2-4 C-atoms. Examples thereof include ethylene glycol, propylene diol and butylene diol. Preferably propylene diol or butylene diol are used, more preferably 1,4-butylene diol. Examples of suitable aromatic dicarboxylic acids include terephthalic acid, 2,6-naphthalenedicarboxylic acid, 4,4′-biphenyldicarboxylic acid or combinations of these. The advantage thereof is that the resulting polyester is generally semi-crystalline with a melting point of above 150, preferably above 175, and more preferably of above 190° C. The hard segments may optionally further contain a minor amount of units derived from other dicarboxylic acids, for example isophthalic acid, which generally lowers the melting point of the polyester. The amount of other dicarboxylic acids is preferably limited to not more than 10, more preferably not more than 5 mol %, based on the total amount of dicarboxylic acids, so as to ensure that, among other things, the crystallization behaviour of the copolyether ester is not adversely affected. The hard segment is preferably built up from ethylene terephthalate, propylene terephthalate, and in particular from butylene terephthalate as repeating units. Advantages of these readily available units include favourable crystallisation behaviour and a high melting point, resulting in a thermoplastic elastomer according to the invention with good processing properties, excellent thermal and chemical resistance and good puncture resistance.

Good results are obtained if the amount of epoxidized vegetable oil is between 10 and 200 wt. % of the amount of residues of the dimerised fatty acid and/or its derivative. Preferably the amount of epoxidized vegetable oil in the composition is at least 30 wt. %, more preferably at least 50 wt. %, more preferably at least 70 wt. % of the amount of residues of the dimerised fatty acid and/or its derivative. Preferably the amount of epoxidized vegetable oil is at most 150 wt. %, more preferably at most 100 wt. %, even more preferably at most 80 wt. % of the amount of residues of the dimerised fatty acid and/or its derivative.

The composition according to the invention may be produced by mixing the epoxidized oil and a granulate containing the polymer containing the residue of the dimerised fatty acid and/or derivatives thereof in a tumble mixer and keeping it at elevated temperature until the epoxidized vegetable oil has penetrated into the granulate. Thereafter it is possible to process the so obtained granulate of the composition according to the invention by for example injection molding, blow molding or extrusion into shaped articles.

Preferably the composition according to the invention is produced by melt mixing the composition in for example a twin screw extruder. It is possible to add the polymer containing the residue of the dimerised fatty acid and/or a derivative thereof via the first feed opening of the extruder and to inject the epoxidized vegetable oil at one or more points into the extruder.

The composition according to the invention may be used for the production of shoe soles, tubes, cable jackets, soft touch applications, CVJ boots etc.

The invention is explained by the examples below, without being restricted to the examples.

### Materials Used.

Polymer 1: Polymer containing 15 wt. % of residues of a dimerised fatty acid having 36 C-atoms, the balance being hard segments of 1,4-butylene diol and terphthalic acid.
Polymer 2: Like polymer 1, but containing 30 wt. % of the residues of the dimerised fatty acid.
Polymer 3: Polymer containing 35 wt. % of residues of a dimerised fatty acid and a dimerised fatty amine, both having 36 C-atoms, the balance being hard segments of 1,4-butylene diol and terphthalic acid.
Polymer 4: Like polymer 3, but containing 50 wt. % of residues of a dimerised fatty acid and a dimerised fatty amine.
Polymer 5: Like polymer 3, but containing 42 wt. % of residues of dimerised fatty acid and dimerised fatty amine.
Polymer 6: Like polymer 3, but containing 55 wt. % of residues of dimerised fatty acid and dimerised fatty amine.
ESO: Drapex™ 39, epoxidized soy bean oil, delivered by Chemtura corp. USA. ELO: Drapex™ 10.4, epoxidized linseed oil, delivered by Drapex corp. USA.

### Test Procedures.

The melting point (Tm) was determined by DSC, using a Mettler DSC 828D. From a grain of granulate of the polymer about 8 mg of material was put in a sample holder. The material and sample holder were placed in the DSC apparatus, heated to 250° C. and cooled down to room temperature again, both at a rate of 10° C./min. Thereafter the temperature was raised by 10° C./min. The melting point was determined from the maximum of the peak of heat of crystallization.

The E-Modulus was determined at different temperatures by using a Rheometrics RSA-II DMS at a frequency of 1 Hz and heating rate of 5° C./min on samples of about 2.0 mm width, 0.09 mm thickness and length between clamps of about 21.8 mm, which method follows ASTM D5026. The E-modulus at 23° C. is reported. The samples were cut from a film obtained by drying granulate of the polymer for 16 hours at 110° C. under vacuum and producing the film by compression molding the granulate into the film at 250° C.

### PREPARATION OF COMPOSITIONS OF EXAMPLE 1 AND COMPARATIVE EXPERIMENT C

Polymer 1 and 2 containing respectively 15 wt. % of the residue of the dimerised fatty acid was fed to a Werner and Pfleiderer™ co-rotating twin screw extruder having a screw diameter of 30 mm. Soy beam oil and epoxidized soil bean oil were injected between the melting zone and the mixing zone of the twin screw extruder at an injection point 10D from the exit of the extruder. The melt temperature at the exit was 240° C., the output was 20 kg.h.

### Example I

Is a composition of polymer 1 and epoxidized soy bean oil. The composition contains 85 wt. % of the polymer and 15 wt. % of the epoxidized soy bean oil. The total composition contains 12.7 wt. % of the residues of dimerised fatty acid, so that: amount of dimerised fatty acid +amount of epoxidized soy bean oil =27.7 wt. %. Tm, Tg and the E-modulus at 23° C. were determined. The results are presented in table 1.

### Comparative Experiments A

Is a composition consisting of polymer 1, comprising 15 wt. % of dimerised fatty acid residues. The results are presented in table 1.

### Comparative Experiment B

Is a composition consisting of polymer 2, comprising 30 wt. % of dimerised fatty acid residues. The results are presented in table 1.

### Comparative Experiment C

Like example 1, however the soy bean oil used is not epoxidized. The results are presented in table 1.

TABLE 1

| Examples/ | DFA | ESO | SO | Total | Emod. 23° C. | Tm | Tg |
|---|---|---|---|---|---|---|---|
| Comp. exp. | wt. % | wt. % | wt. % | wt. % | [Mpa] | [° C.] | [° C.] |
| A | 15 | | | | 787 | 213 | 11 |
| B | 30 | | | | 213 | 196 | −13 |
| C | 15 | | 15 | 27.7 | 837 | 215 | 7 |
| I | 15 | 15 | | 27.7 | 301 | 220 | −43 |

DFA: wt. % of dimerised fatty acid residues in the polymer.
ESO: wt. % of epoxidized soy been oil in the composition of the polymer.
SO: wt. % of soy been oil in the composition of the polymer.
Total: wt. % of DFA and oil in the composition.

From comparing comparative experiments A-B it is clear that increasing the amount of residues of dimerised fatty acids in the polymer results in a high decrease in modulus and a decrease in melting temperature. The addition of soy been oil (see comparative experiment A versus C) almost has no effect on the glass transition temperature.

The addition of epoxidized soy bean oil (see comparative experiment A versus example I) on the contrary shows a remarkable decrease in glass transition temperature and the decrease in E modulus is less.

### PREPARATION OF THE COMPOSITIONS OF EXAMPLES II AND III

A mixture of respectively 90 wt. % of polymer 2 and 3 with 10 wt. % of epoxidized linseed oil (ELO) was heated in a round bottom flask at 150° C. for 120 minutes so that the linseed oil was allowed to diffuse into the polymer under nitrogen.

### Example II

Is a composition of polymer 3 and epoxidized linseed oil. The composition contains 90 wt. % of the polymer and 10 wt. % of the epoxidized soy bean oil. The total composition contains 31.5 wt. % of the residues of dimerised fatty acid and the dimerised fatty diamine, so that: amount of dimerised fatty acid and dimerised fatty amine +amount of epoxidized linseed oil =41.5 wt. %. Tm, Tg and the E-modulus at 23° C. were determined. The results are presented in table 2.

### Example III

Is a composition of polymer 4 and epoxidized linseed oil. The composition contains 90 wt. % of the polymer and 10 wt. % of the epoxidized soy bean oil. The total composition contains 45 wt. % of the residues of dimerised fatty acid and the dimerised fatty diamine, so that: amount of dimerised fatty acid and dimerised fatty amine +amount of epoxidized linseed oil =55 wt. %. Tm, Tg and the E-modulus at 23° C. were determined. The results are presented in table 2.

### Comparative Experiment D

Is a composition consisting of polymer 5, comprising 42 wt. % residues of dimerised fatty acid and dimerised fatty amine. The results are presented in table 1.

### Comparative Experiment E

Is a composition consisting of polymer 6, comprising 55 wt. % residues of dimerised fatty acid and dimerised fatty amine. The results are presented in table 1.

TABLE 2

| Examples/ | DFA | ELO | Total | Emod. 23° C. | Tm | Tg |
|---|---|---|---|---|---|---|
| Comp. exp. | wt. % | wt. % | wt. % | [Mpa] | [° C.] | [° C.] |
| II | 35 | 10 | 41.5 | 155 | 200 | −25 |
| III | 50 | 10 | 55 | 40 | 192 | −30 |
| D | 42 | | | — | 196 | −17 |
| E | 55 | | | 57 | 190 | −23 |

DFA: wt. % of dimerised fatty acid and dimerised fatty amine residues in the polymer.
ELO: wt. % of epoxidized linseed oil in the composition of the polymer.
Total: wt. % of DFA and epoxidized linseed oil in the composition.

From the comparison of example II and comparative experiment D it is clear that by exchanging part of the residues of dimerised fatty acid and the dimerised fatty diamine with ELO, that the Tg goes down and the melting point goes up. The same is true for the comparison of example Ill and comparative experiment E.

1. A polymer composition containing a polymer, which polymer contains a residue of a dimerised fatty acid and/or a derivative thereof, characterized in that the polymer composition contains an epoxidized plasticizer.

2. A polymer composition according to claim 1, wherein the epoxidized plasticizer is an epoxidized vegetable oil.

3. A polymer composition according to claim 2, wherein epoxidized vegetable oil is epoxydized soy bean oil, epoxidized linseed oil or epoxidized tall oil.

4. A polymer composition according to claim 2, wherein epoxidized vegetable oil is epoxydized soy bean oil.

5. Polymer composition according to claim 1, wherein the amount of oxyrane oxygen is 0.1-15 wt. %.

6. A polymer composition according to claim 1, wherein the polymer is thermoplastic elastomer, containing hard segments of a polyester, a nylon or a polycarbonate.

7. A polymer composition according to claim 1, wherein the polymer is thermoplastic elastomer, containing hard segments of a polyester.

8. A polymer composition according to claim 7, wherein the polyester hard segments contain repeating units of 1,4-butylene diol and terephthalic acid.

9. A polymer composition according to claim 1, wherein the polymer contains residues of a dimerised fatty acids and residues of a dimerised fatty amine.

10. A polymer composition according to claim 1, wherein the amount of epoxidized vegetable oil is between 10 and 200 wt. % of the total amount of residues of dimerised fatty acid and/or its derivative.
